(19) United States
(12) Patent Application Publication
(10) Pub. No.: US 2011/0089140 A1
(43) Pub. Date: Apr. 21, 2011

(54) PROCESS FOR FABRICATING ULTRA-NARROW TRACK WIDTH MAGNETIC SENSOR

(76) Inventor: Liubo Hong, San Jose, CA (US)

(21) Appl. No.: 12/581,042

(22) Filed: Oct. 16, 2009

(51) Int. Cl. B44C 1/22

(52) U.S. Cl. 216/22

(57) ABSTRACT

A method for manufacturing a magnetoresistive sensor at very small dimensions with well a controlled track width and clean damage free side wall junctions. The method uses nano-imprinting rather than photolithography to pattern a resist layer. This eliminates the track width variations inherent in photolithographic patterning. The use of nano-imprinting also eliminates the need for a bottom anti-reflective coating beneath the resist layer, thereby also eliminating the need for an additional etch process to remove the bottom anti-reflective coating, which would also cause variations in track width.

### RELATED INVENTIONS

This invention is related to commonly assigned patent application Ser. No. ______, entitled PROCESS FOR FABRICATING AN ULTRA-NARROW DIMENSION MAGNETIC SENSORS, filed ______.

### FIELD OF THE INVENTION

The present invention relates to magnetic tunneling devices and more particularly to a method for manufacturing a magnetoresistive sensor having an ultra-narrow track-width and well controlled side junction profile.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating but, when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

In recent read head designs a spin valve sensor, also referred to as a giant magnetoresistive (GMR) sensor, has been employed for sensing magnetic fields from the rotating magnetic disk. The sensor includes a nonmagnetic conductive layer, hereinafter referred to as a spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

The push for ever increased data rate and data capacity has lead a drive to increase the performance and decrease the size of magnetoresistive sensors. Such efforts have lead to an investigation into the development of tunnel junction sensors or tunnel valves. A tunnel valve operates based on the quantum mechanical tunneling of electrons through a thin electrically insulating barrier layer. A tunnel valve includes first and second magnetic layers separated by a thin, non-magnetic barrier. The probability of electrons passing through the barrier layer depends upon the relative orientations of the magnetic moment of the first and second magnetic layers. When the moments are parallel, the probability of electrons passing through the barrier is at a maximum, and when the moments are antiparallel, the probability of electrons passing through the barrier is at a minimum.

In the push for ever greater data density, researchers have sought means for decreasing the dimensions of magnetoresistive sensors, especially the track-width of such sensors. However, manufacturing limitations have limited the ability to reliably reduce the track-width of such sensors, while also maintaining controllability of well defined side junction profiles of the sensors.

### SUMMARY OF THE INVENTION

The present invention provides a method for manufacturing a magnetoresistive sensor that includes first providing a substrate and then depositing a plurality of sensor layers over the substrate. A mask structure is then deposited over the substrate and a resist layer is deposited over the mask structure. Nano-imprinting is then used to form a patterned resist layer. The image of the patterned resist layer is transferred onto the mask layer. An ion milling can then be performed to remove portions of the plurality of sensor layers that are not protected by the mask layer.

The mask layer can include a first etch mask layer and a second etch mask layer formed over the first etch mask layer. The first and second etch mask layers can be constructed of materials that are removable by reactive ion etching with different chemistries. For example, the first etch mask layer can be constructed of a soluble polymer or PMGI, which is removable by reactive ion etching in an oxygen chemistry and which is resistant to removal by reactive ion etching in a fluorine chemistry and is also resistant to removal by ion milling. The second etch mask layer can be constructed of a material such as SiO₂, SiNₓ, SiOₓN_{y}, SiC, or Ta, which is removable by reactive ion etching in a fluorine chemistry and may be removable by ion milling, but is resistant to removal by reactive ion etching in an oxygen chemistry.

An optional protective layer, constructed of a material such as diamond like carbon (DLC) or amorphous carbon can be provided after the sensor layers and before the first etch mask layer to protect the sensor layers during subsequent processing.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3; is an enlarged ABS view of a magnetoresistive sensor such as can be manufactured according to an embodiment of the invention; and

FIGS. 4-11 show an ABS view of a magnetoresisitve sensor in various intermediate stages of manufacture in order to illustrate a method of manufacturing a magnetoresistive sensor according to an embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

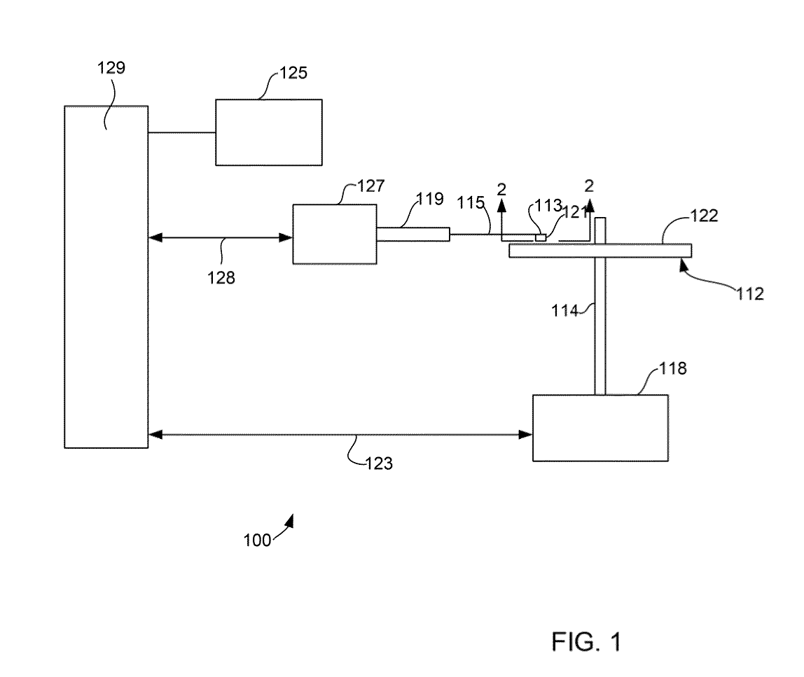

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are read from or written to. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

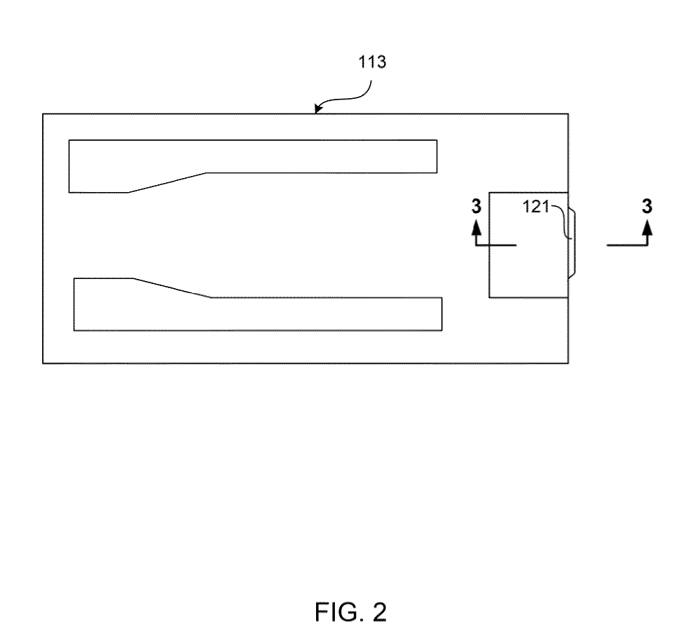

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

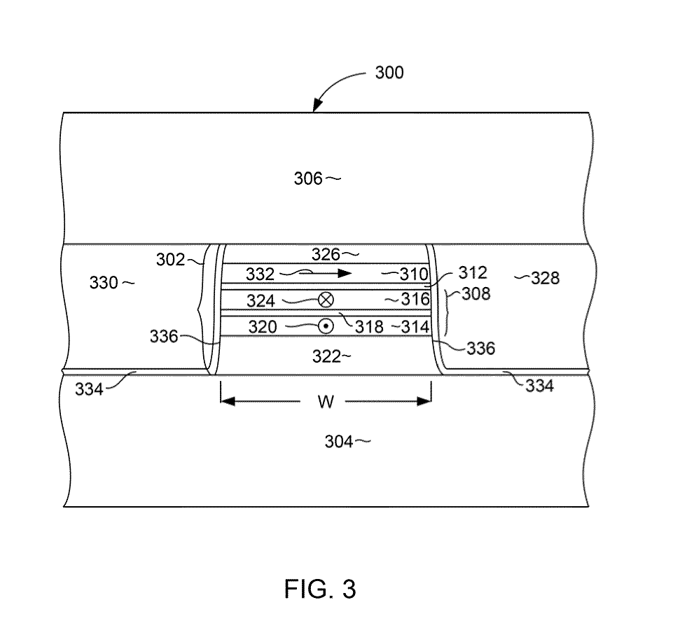

With reference now to FIG. 3, a schematic illustration is shown of a magnetoresistive sensor 300 as viewed from a plane parallel with the Air Bearing Surface (ABS). The sensor 300 includes a sensor stack 302 that is sandwiched between first and second electrically conductive shields 304, 306 that can be constructed of a magnetic material so that they can function as magnetic shields as well as electrical leads.

The sensor stack 302 can include a magnetic pinned layer structure 308, a magnetic free layer structure 310 and a non-magnetic spacer or barrier layer 312 sandwiched there-between. If the sensor 300 is a giant magnetoresistive sensor (GMR) the layer 312 will be an electrically conductive, non-magnetic spacer layer constructed of a material such as Cu. If the sensor 300 is a tunnel junction magnetoresistive sensor (TMR) the layer 312 will be a thin, non-magnetic electrically insulating barrier layer such as Mg—O, alumina or TiO₂.

The pinned layer structure 308 can be an antiparallel coupled structure that includes first and second magnetic layers AP1 314 and AP2 316, which are antiparallel coupled across a thin, non-magnetic AP coupling layer 318 such as Ru. The AP1 layer 314 has magnetization that is pinned in a first direction perpendicular to the ABS as indicated by arrow-head symbol 320. Pinning of the magnetization 320 is achieved by exchange coupling with a layer of antiferromagnetic material (AFM) layer 322, which may be a material such as PtMn, IrMn or some other suitable material. Antiparallel coupling between the AP1 layer 314, and AP2 layer 316 pins the magnetization of the AP2 layer 316 in a second direction perpendicular to the ABS as indicated by arrow tail symbol 324.

In addition to the free layer 310, pinned layer structure 308 and spacer or barrier layer 312, a capping layer 326 including one or more layers of Ta and/or Ru may be provided at the top of the sensor stack 302 to protect the sensor layers during manufacture. First and second hard bias layers 328, 330, constructed of a material such as CoPt or CoPtCr can be provided at either side of the sensor stack 302 to provide a magnetic bias field for biasing the magnetization of the free layer 310 in a desired direction parallel with the ABS as indicated by arrow symbol 332. The hard bias layers 328, 330 can each be separated from the sensor stack 302 and from at least one of the lead layers 304 by a thin insulation layer 334 in order to prevent sense current from being shunted through the hard bias layers 328, 330.

In operation, an electrical sense current is passed through the sensor stack 302 from one of the leads 306 to the other lead 304. In this way, the electrical resistance across the sensor stack can be measured. This resistance across the sensor stack varies with the relative orientations of the free layer magnetization 332 and pinned or reference layer magnetization 324. The closer these magnetizations are to being parallel to one another the lower the resistance will be, and the closer these magnetizations are to being anti-parallel the higher the resistance will be. As mentioned above, the magnetization 324 is pinned. However, the magnetization 332 is free to rotate in response to a magnetic field. Therefore, by measuring the change in electrical resistance across the sensor stack 302, the presence and strength of an external magnetic field can be sensed.

The width of the sensor stack 302 (and more specifically the width of the barrier/spacer layer 312 and free layer 310) determines the track width (TW) of the sensor 300. As discussed above, the track-width of the sensor is an important parameter, because a smaller track-width is needed to increase data density. Another important design parameter is the definition of the sides of the sensor stack 302, also referred to as the junction. Control of the side junctions 334, 336 includes controlling the angle of these sides and the smoothness of the side curvature, and also includes making sure that damage to the material layers at the sides is minimized and the amount of re-deposited material (re-dep) is minimized.

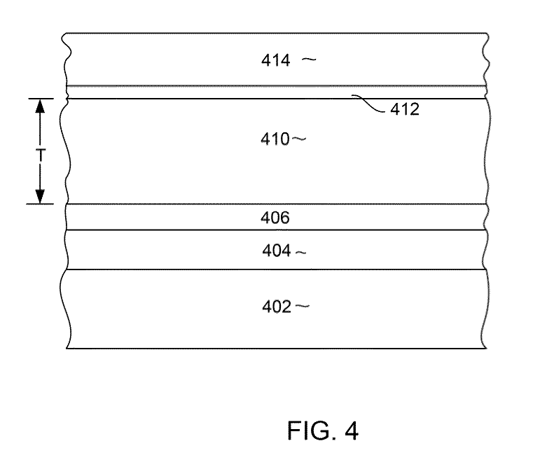

FIGS. 4-11, illustrate a method for manufacturing a magnetoresisitive sensor that allows the track-width of the sensor to be reduced and uniform, while also maximizing side junction definition uniformity. With particular reference to FIG. 4, a lower magnetic, electrically conductive lead 402 is formed, and a plurality of sensor layers 404 are deposited over the lead 402. The lead 402 provides a substrate for the deposition of the sensor layers there-over. The sensor layers 404 can include layers that can form a sensor stack 302 such as that described with reference to FIG. 3. The sensor layers 404 could include layers of any of a number of other types of sensors too, with the sensor stack 302 of FIG. 3 being merely an example.

With continued reference to FIG. 4, an optional protective layer 406 can be deposited over the sensor layers. The optional protective layer 406 can be constructed of a material such as Diamond Like Carbon (DLC) or amorphous carbon. A first etch mask 410 is deposited over the optional protective layer, and a second etch mask 412 is deposited over the first etch mask 410. The first etch mask 410 is deposited to a thickness T that, together with the second etch mask layer 412 will define a desired mask height for a future ion milling operation that will be described herein below. The second etch mask 412 can be made significantly thinner than the first etch mask 410. A layer of photoresist 414 is deposited over the second etch mask 412. No bottom antireflective coating (BARC) is needed under the photoresist mask 414, for reasons that will become apparent below. The first etch mask layer 410, and second etch mask layer 412 are constructed of materials that are removable by different reactive ion etching processes. In other words, the first etch mask 410 is constructed of a material that can be selectively removed by a reactive ion etching that will leave the second etch mask 412 substantially intact. Similarly, the second etch mask 412 is selectively removable by a reactive ion etching process that will leave the first etch mask substantially intact. In addition, the first etch mask 410 is constructed of a material that is resistant to ion milling. To this end, the first etch mask layer 410 can be constructed of a soluble polymer material (preferably a polymer that is soluble in NMP solution) such as DURIMIDE® or polymethylglutarimide (PMGI). The second etch mask 412 can be constructed of a material such as SiO₂, SiNₓ, SiOₓN_{y}, SiC, or Ta. NMP is the more commonly used acronym for the chemical C5H9NO, also known as N-Methylpyrrolidone. This chemical is also known by other names, such as N-Methyl-2-pyrrolidone, and for simplicity's sake will be referred to herein simply as “NMP”.

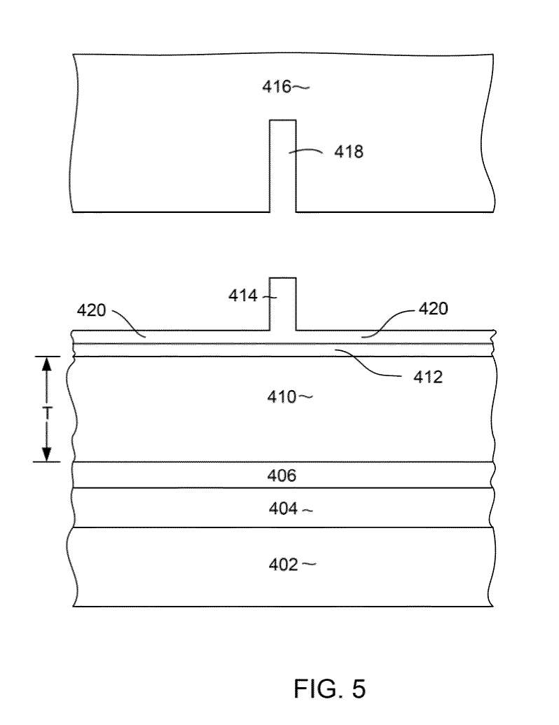

With reference now to FIG. 5, the photoresist layer 414 is patterned by nano-imprinting. This is performed using a nano-imprinting mold 416 having a patterned imprint or groove 418. The mold 418 is pressed onto the resist layer 414, resulting in a desired pattern as shown in FIG. 5. Heat may be applied during the nano-imprinting process to cure or harden the resist layer 414 somewhat. The nano-imprinting process results in a certain amount of resist residue 420 extending from the patterned portion, as shown in FIG. 5.

Prior art methods for manufacturing magnetoresistive sensors have used photolithographic techniques to pattern and develop the resist layer 414. This also required the use of a bottom anti-reflective coating (not shown) directly beneath the resist layer 414. This BARC layer would then be etched away after the resist layer had been patterned. This extra etching step resulted in unwanted variation in the width of the resist mask, resulting in sensor track width variation. Another major source of track width variation using such a prior art method resulted from variations in the photolithographic process itself, both flash field to flash field, within wafer and wafer to wafer. This variation increased substantially when the print resist critical dimension (i.e. width) went below a certain limit, such as 60-75 nm. The above described nano-imprinting method eliminates these sources of track-width variation, because the same mold is used for all flash fields within wafer and for many wafers, allowing a sensor to be constructed at very narrow track widths with an extremely consistent, well controlled track width.

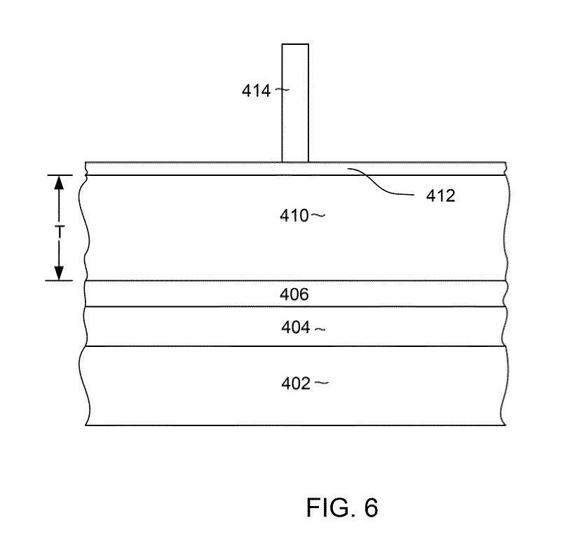

A first reactive ion etching (RIE) is performed to remove the residual portion 420 of the patterned resist 414. This first RIE is preferably performed in an oxygen containing atmosphere. This leaves a structure as shown in FIG. 6, with the resist mask 414 formed above the second hard mask layer 412.

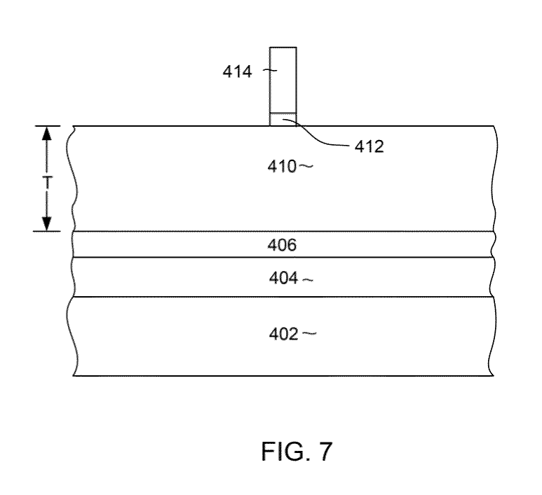

Then, with reference to FIG. 7, a second reactive ion etching is performed to remove portions of the second etch mask layer 412 that are not protected by the resist mask 414, thereby transferring the image of the resist mask 414 onto the underlying second etch mask 412. This second RIE is performed using a gas that preferentially removes the second etch mask layer 412 while leaving the first etch mask layer 410 substantially intact. For example if the second etch mask 412 is constructed of SiO₂, SiNₓ, SiOₓN_{y} or SiC, then the second RIE is performed in an atmosphere that contains fluorine.

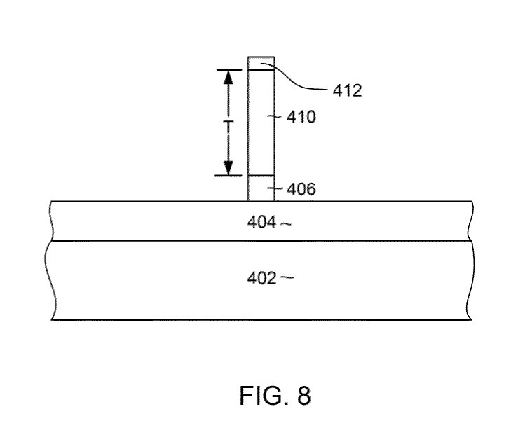

Then, with reference to FIG. 8, a third reactive ion etching (RIE) is performed to remove portions of the first etch mask layer 410 that are not protected by the second etch mask layer 412, thereby transferring the image of the second etch mask layer 412 onto the underlying first etch mask layer. This third RIE is performed using a chemistry that selectively removes portions of the first etch mask layer 410 that are not protected by the second etch mask layer 412, while removing little, if any, of the second etch mask layer 412. To this end, the third RIE is preferably performed in an atmosphere that contains oxygen. This third RIE can also be used to remove portions of the optional protective layer 406 (if the protective layer 406 is used), in order to transfer the image of the over-lying mask layers 410, 412 onto the protective layer 406.

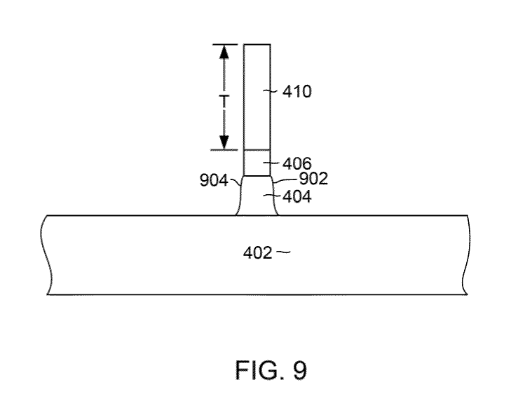

With the first etch mask 410, and optional protective layer 406 patterned, an ion milling process can be performed to remove portions of the sensor material 404 that are not protected by the mask layers 406, 410, thereby forming a sensor 404 with clean, well defined sides as shown in FIG. 9. The ion milling process actually involves a series of ion milling operations performed at various angles relative to normal so as to form a sensor 404 with well defined sides, repeatable, uniform side walls that have little or no damage or re-deposited material (re-dep). This ion milling also removes any of the second etch mask layer 412 (FIG. 8) that remained after the third RIE.

The formation of a read sensor has unique requirements that are not shared by the formation of other devices such as magnetic write heads or semiconductor devices, such as the necessity to form the sensor 404 with clean, well defined side junctions 902, 904. In order to accurately define the side junctions 902, 904, a certain well defined amount of shadowing from the mask layers 406, 410 must be present during the ion milling, and this amount of shadowing must be consistent and well controlled. According to the present invention, the thickness of the protective layer 406, thickness T of the first etch mask layer 410, and thickness of the second mask layer 412 (shown in FIG. 9) can be easily and accurately controlled to desired design thicknesses through the above processes. The optional protective layer 406 is much thinner than the mask layer 410, so that its thickness is a very small portion of the total mask thickness. Therefore, any variation in the thickness of the protective layer 406 has little impact in the overall mask thickness. The thickness of the second mask layer 412 is much thinner than that of the thickness T of the first etch mask layer 410 and it is substantially unchanged during the third RIE process used to etch the first etch mask layer 410, and its variation has a very small impact on the overall mask thickness. Previously disclosed processes resulted in a reduction in the height of the overall mask thickness during formation of the mask itself. This made it impossible to control the overall thickness of the mask layers, especially at extremely narrow track widths at the start of the ion milling process. In the method of the present invention, the ion milling process reduces the mask height, but the process is repeatable in that the starting mask height is consistent and easily controlled.

The above described process makes it possible to control mask thickness precisely and controllably from wafer to wafer for the ion milling process that defines the sensor junction. The ion milling mask consists of the first etch mask 410, second etch mask 412 and protective layer 406. The thickness T of the first mask 410 remains the exact thickness at which it was deposited. In other words, the thickness T is controlled by deposition of the layer 410, which can be accurately and consistently controlled. This is also true of the protective layer 406. The thickness of the second mask 412 is little changed by the third RIE process in FIG. 8 and its thickness at the start of ion milling process is substantially controlled by the deposition process that deposits it.

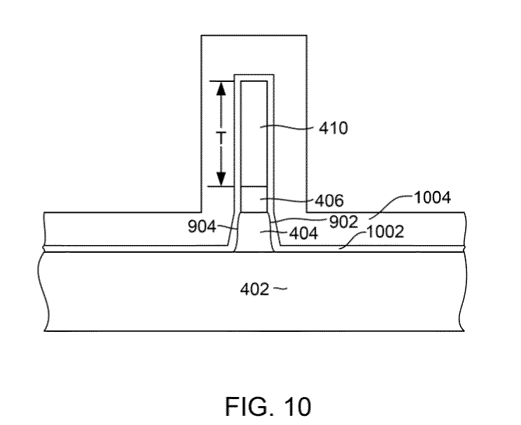

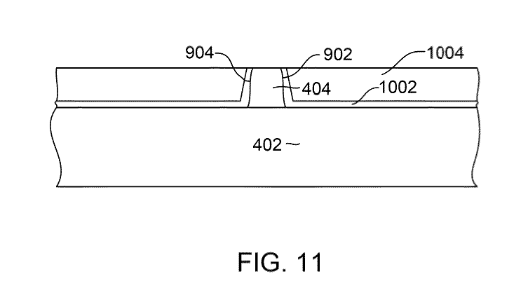

With reference now to FIG. 10, a thin layer of non-magnetic, electrically insulating material 1002 can be deposited, followed by a hard magnetic material 1004. The deposition of the hard magnetic layer 1004 can be preceded by the deposition of one or more seed layers (not shown) that initiate a desired grain structure in the above deposited hard magnetic bias layer 1004. The insulation layer 1002 can be alumina and can be deposited by atomic layer deposition. The hard bias material layer 1004 can be a material such as CoPt or CoPtCr and can be deposited by sputter deposition. One or more capping layers (not shown) may be deposited after the hard magnetic material 1004. Then, a liftoff process can be performed to remove the mask layers 410. A chemical mechanical polishing process may be used as well to assist lift-off of the mask and to planarize the surface of the structure. The optional protective layer 406 may be removed. This leaves a structure as shown in FIG. 11. Thereafter, a second shield can be deposited such as the shield 306 shown in FIG. 3.

While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetoresistive sensor, comprising:
providing a substrate;
depositing a plurality of sensor layers over the substrate;
depositing a mask layer over the substrate;
depositing a resist layer over the mask layer;
imprinting a pattern onto the resist layer using nano-imprinting to form a patterned resist layer;
transferring the image of the patterned resist layer onto the underlying mask layer; and
performing an ion milling process to remove portions of the plurality of sensor layers that are not protected by the mask layer.

2. The method as in claim 1 wherein the nano-imprinting of the resist layer results in a residual resist portion, the method further comprising, after patterning the resist layer, performing a reactive ion etching to remove the residual resist portion.

3. The method as in claim 1 wherein there is no bottom anti-reflective coating directly beneath the resist layer.

4. The method as in claim 2 wherein the reactive ion etching used to remove the residual resist portion is performed in an atmosphere that contains oxygen.

5. The method as in claim 1 wherein the ion milling process includes a plurality of ion milling operations performed at a various angles relative to normal to form clean, damage free sides on the plurality of sensor layers.

6. The method as in claim 1 wherein the mask layer comprises a material that is removable by reactive ion etching.

7. The method as in claim 1 wherein the mask layer comprises a soluble polymer or polymethylglutarimide.

8. The method as in claim 1 wherein the mask layer comprises a polymethylglutarimide or a polymer that is soluble in NMP.

9. The method as in claim 1 wherein the mask layer comprises a first layer that comprises a soluble polymer or polymethylglutarimide and a protective layer located between the first layer and the plurality of sensor layers.

10. The method as in claim 9 wherein the protective layer comprises diamond like carbon or amorphous carbon.

11. A method for manufacturing a magnetoresistive sensor, comprising:
providing a substrate;
depositing a plurality of sensor layers onto the substrate;
depositing a first etch mask layer, the first etch mask layer being removable by a reactive ion etching in a first chemistry and resistant to removal by reactive ion etching in a second chemistry and resistant to removal by ion milling;
depositing a second etch mask layer over the first etch mask layer, the second etch mask layer being removable by reactive ion etching in the second chemistry but resistant to reactive ion etching in the first chemistry;
depositing a layer of resist over the second etch mask layer;
patterning the resist layer using nano-imprinting to form a patterned resist mask;
performing a reactive ion etching in the second chemistry to transfer the image of the patterned resist mask onto the second etch mask;
performing a reactive ion etching in the first chemistry to transfer the image of the second etch mask onto the first etch mask; and
performing an ion milling process to remove portions of the plurality of sensor layers that are not protected by the first mask layer.

12. The method as in claim 11 wherein the nano-imprinting of the resist to form a patterned resist mask also leaves residual resist, the method further comprising performing a reactive ion etching to remove the residual resist prior to performing the reactive ion etch to transfer the image of the patterned resist onto the second etch mask layer.

13. The method as in claim 12 wherein the reactive ion etching to remove the residual resist is performed in an oxygen chemistry.

14. The method as in claim 11, wherein:
the reactive ion etching to transfer the image of the patterned resist onto the underlying second etch mask layer is performed in a fluorine chemistry, and
the reactive ion etching to transfer the image of the second etch mask onto the first etch mask is performed in an oxygen chemistry.

15. The method as in claim 11, wherein:
the first etch mask comprises a soluble polymer or polymethylglutarimide; and
the second etch mask comprises SiO₂, SiNₓ, SiOₓN_{y}, SiC, or Ta.

16. The method as in claim 11, wherein:
The first etch mask comprises a polymethylglutarimide or a polymer that is soluble in NMP; and
The second etch mask comprises SiO₂, SiNₓ, SiOₓNy, SiC or Ta.

17. The method as in claim 11, wherein:
the first etch mask comprises a soluble polymer or polymethylglutarimide;
the second etch mask comprises SiO₂, SiNₓ, SiOₓN_{y}, SiC, Ta;
the reactive ion etching used to transfer the image of the patterned resist onto the second etch mask layer is performed in a fluorine chemistry; and
the reactive ion etching used to transfer the image of the second etch mask layer onto the first etch mask layer is performed in an oxygen chemistry.

18. The method as in claim 11 wherein the ion milling process includes a series of ion millings performed at various angles relative to normal such that shadowing from the first etch mask layers causes the ion milling process to form clean, damage free side walls on the plurality of sensor layers.

19. The method as in claim 11 further comprising, after depositing the plurality of sensor layers, and before depositing the first etch mask layer, depositing a protective layer.

20. The method as in claim 19 wherein the protective layer comprises diamond like carbon or amorphous carbon.
